(19) United States
(12) Patent Application Publication
(10) Pub. No.: US 2007/0268258 A1
(43) Pub. Date: Nov. 22, 2007

(54) HAND-HELD DEVICE WITH CHARACTER INPUT ROTARY WHEEL

(75) Inventors: Chin-Feng Chen, Shenzhen (CN); Tay-Yang Lin, Shenzhen (CN); Xiao-Guang Li, Shenzhen (CN); Te-Yao Yeh, Shenzhen (CN); Kuan-Hong Hsieh, Shenzhen (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/309,737

(22) Filed: Sep. 20, 2006

(30) Foreign Application Priority Data
May 19, 2006 (CN) 200610060716.6

(51) Int. Cl. G09G 5/00

(52) U.S. Cl. 345/169

(57) ABSTRACT

A hand-held device is provided. The hand-held device includes a rotary wheel, a switch, a character region, a display, and a controller. The rotary wheel has a plurality of positioning inputs. The character region includes a plurality of icons corresponding to the positioning inputs. Each icon includes a plurality of characters. The display defines a character display area. According to a positioning input the rotary wheel locates, the characters of the corresponding icon are displayed in the character display area of the display. According to a count the switch is operated, the corresponding character of the characters displayed in the character display area is inputted. The above-mentioned rotary wheel can replace keyboard in the hand-held device.

### 1. FIELD OF THE INVENTION

The present invention relates to a hand-held device; and particularly to a hand-held device with a character input rotary wheel.

### 2. DESCRIPTION OF RELATED ART

Hand-held devices, for example, mobile phones and PDAs, usually adopts a keypad to input characters. The keypad typically has fewer keys than a QWERTY keyboard. Furthermore, the key's size is smaller than a key's size of a normal keyboard. A user usually needs to operate keys a plurality of times to input one character. It is uncomfortable to operate small sized keys.

Rotary wheels are used as input apparatus in hand-held devices. For example, U.S. patent application Ser. No. 10/259,159, published May 22, 2003, entitled “Method and apparatus for use of rotational user inputs,” it discloses a media player. The media player includes a display screen and an input device. The display screen displays media items. User rotates the input device to select a media item. U.S. Pat. No. 6,842,169, issued Oct. 19, entitled “Hand-held electronic device with multiple input mode thumbwheel,” it discloses a hand-held electronic device. The electronic device includes a thumbwheel as an auxiliary input device. Rotary wheels are used to select menu items, move cursor, but are unable or inconvenient to use as character input device.

Therefore what is needed is a hand-held device with a character input rotary wheel.

### SUMMARY OF THE INVENTION

A hand-held device is disclosed. The hand-held device includes a rotary wheel, a switch, a character region, a display, and a controller. The rotary wheel has a plurality of positioning inputs. The display comprises a character display area. The character region comprises a plurality of icons corresponding to the positioning inputs, wherein each icon comprises a plurality of characters. The controller is responsive to the rotary wheel and the switch, and controls the display, wherein characters of an icon is displayed in the character display area of the display according to a positioning input the rotary wheel locates, a character of the characters is inputted according to a count the switch is operated.

Another kind of hand-held device with character input rotary wheel is disclosed. The hand-held device includes a rotary wheel, a switch, an encoder, a display, and a controller. The rotary wheel has a plurality of positioning inputs. The display comprises a character display area. The encoder is responsive to the rotary wheel and outputs positioning codes. The controller is responsive to the encoder and the switch, controls the display, and keeps characters corresponding to the positioning codes, wherein characters is displayed in the character display area of the display according to a positioning input the rotary wheel locates, a character of the characters is inputted according to a count the switch is operated.

Further features will be described or will become apparent in the course of the following detailed description when read in conjunction with the attached drawings, in which:

### BRIEF DESCRIPTION OF THE DRAWINGS

FIG. 1 is a schematic, front view of a hand-held device with a character input rotary wheel according to a preferred embodiment of the present invention;

FIG. 2 is a schematic diagram of a hardware infrastructure of the hand-held device of FIG. 1; and

FIG. 3 is a flowchart of a preferred method of inputting character, by using the hand-held device of FIG. 1.

### DETAILED DESCRIPTION OF THE INVENTION

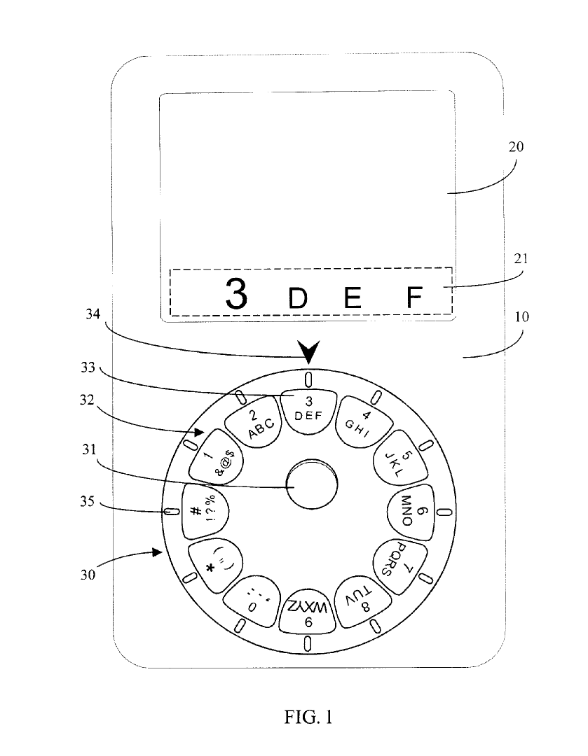

Referring to FIG. 1, a hand-held device is disclosed. The hand-held device 10 includes a display 20 and a rotary wheel 30. The display 20 defines a character display area 21. The rotary wheel 30 has twelve positioning inputs 35 and further has a character region 32 thereon. The character region 32 has twelve icons 33 corresponding to the positioning inputs 35. The twelve icons 33 are arranged in the form of a circle. Each icon 33 may have a corresponding graphical label. The corresponding graphical label can be numbers, letters, symbols, or any combination of them. In this exemplary embodiment as shown in FIG. 1, the corresponding graphical label of the icon 33 is in the form of a combination of numbers, letters, and symbols. Furthermore, the corresponding graphical label has a first part and a second part, each part for providing corresponding characters. For example, as displayed in FIG. 1, the first part of the graphical label provides a single number or symbol, and the second part of the graphical label provides multiple letters or symbols. In addition, the first parts and the second parts of the graphical labels of the icons 33 are arranged in the form of a circle. Each icon 33 can be in a from of a geometrical shape such as a square, a rectangle, a trapezium, a triangle, a circle, an ellipse, or any desired geometrical shape of a designer's choice. For example, in the embodiment as shown in FIG. 1, the icons 33 are in the form of a smooth trapezium. Moreover, the icons 33 are the same, shape-wise or size-wise.

The hand-held device 1 further has an indicator 34. The indicator 34 is positioned between the display 20 and the rotary wheel 30 to indicate the positioning input 35 that the rotary wheel 30 locates. The display 20 displays the graphical label of the icon 33 in the character display area 21 corresponding to the positioning input 35 indicated by the indicator 34. For instance, as shown in FIG. 1, the character display area 21 displays the two parts of the graphical label of the icon 33 in order, i.e., 3 ‘D’, ‘E’, and ‘F’.

The hand-held device 1 further has a switch 31 for selecting a desired character displayed. The switch 31 can be any appropriate input device. For example, in the embodiment as shown in FIG. 1, the switch 31 is in a form of a button. The switch 31 can be positioned in the center of the rotary wheel 30, below the center of the rotary wheel 30, or above the center of the rotary wheel 30 as shown in FIG. 1. Regarding the selection operation on the switch 31, it is described in detail below.

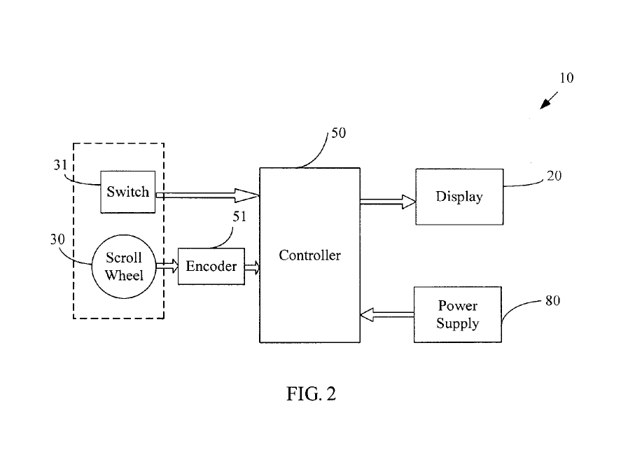

Referring to FIG. 2, a hardware infrastructure of the hand-held device 10 is disclosed. The hand-held device 10 further includes a controller 50, an encoder 51, and a power supply 80. The controller 50 is connected to the switch 31, the encoder 51, the display 20, and the power supply 80. The encoder 51 is further connected to the rotary wheel 30 and generates a positioning code corresponding to the positioning input in response to a rotational input of the rotary wheel 30. Accordingly, the controller 50 obtains the characters of a corresponding icon 33 according to the positioning code from the encoder 51, and displays the characters on the display area 21 of the display 20. Furthermore, the controller 50 acts to select corresponding character in response to selection operation on the switch 31. For example, in response to a press input of the switch 31, the controller 50 selects a first character of the characters displayed in the display area 21, and sends the first character to the display 20. In response to two continuous press inputs on the button 1 and a duration of the further press input is within a predetermined time (for example, 0.5 s), the controller 50 selects and sends the second character to the display 20. If the same character needs to be input again right after the previous input, the user needs to either operate on the rotary wheel 30 again doing the same procedure as he/she did previously or just wait for the predetermined time (for example, 0.5 s) passed and press the switch 31 for the same count to select the same character.

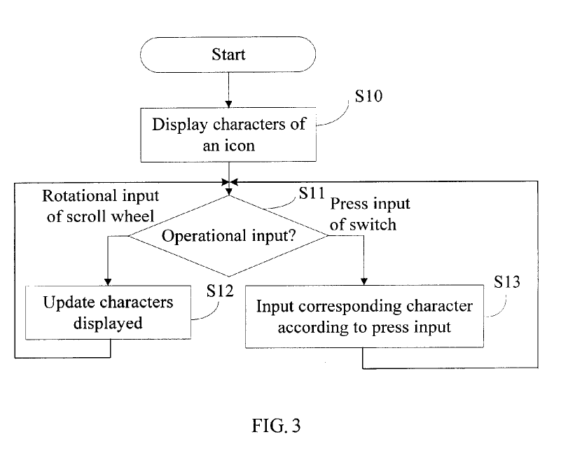

Referring to FIG. 3, a flowchart of a preferred method of inputting characters is disclosed. In step S10, in response to the positioning input where the rotary wheel 30 locates, the encoder 51 generates the corresponding positioning code. The controller 50 acts to obtain the characters of a corresponding icon 33 according to the positioning code, and sends the characters to the display 20. The display 20 displays the characters in the display area 21. In step S11, the controller 50 determines the operational input.

If the operational input is rotational input of the rotary wheel 30, in step S12, the encoder 51 generates a new positioning code. The controller 50 obtains characters of a new icon 33 according to the new positioning code, and sends the characters to the display 20. The display 20 updates the characters displayed in the display area 21 with the characters newly obtained accordingly. The procedure goes back to step S11.

If the operational input is press input of the switch 31, in step S13, the controller 50 selects and sends corresponding character according to the count of the press input. For example, if the switch 31 is pressed down once, the controller 50 selects and sends the first character. If the switch 31 is pressed down twice, the controller 50 selects and sends the second character. And so on. The display 20 displays the character. Then the procedure goes back to step S11.

It is understood that the invention may be embodied in other forms without departing from the spirit thereof. Thus, the present examples and embodiments are to be considered in all respects as illustrative and not restrictive, and the invention is not to be limited to the details given herein.

What is claimed is:

1. A hand-held device comprising:
a rotary wheel having a plurality of positioning inputs;
a display comprising a character display area;
a switch;
a character region comprising a plurality of icons corresponding to the positioning inputs, wherein each icon comprises a plurality of characters;
a controller responsive to the rotary wheel and the switch, and controlling the display;
wherein characters of an icon is displayed in the character display area of the display according to a positioning input the rotary wheel locates, a character of the characters is inputted according to a count the switch is operated.

2. The hand-held device of claim 1, further comprising an indicator to indicate the positioning input the rotary wheel locates.

3. The hand-held device of claim 2, wherein the indicator is placed out of the rotary wheel.

4. The hand-held device of claim 1, wherein the switch is a button.

5. The hand-held device of claim 4, wherein the button is placed on the rotary wheel.

6. A hand-held device comprising:
a rotary wheel having a plurality of positioning inputs;
a display comprising a character display area;
a switch;
an encoder responsive to the rotary wheel and outputting positioning codes;
a controller responsive to the encoder and the switch, and controlling the display, wherein the controller keeps characters corresponding to the positioning codes;
wherein characters is displayed in the character display area of the display according to a positioning input the rotary wheel locates, a character of the characters is inputted according to a count the switch is operated.

7. The hand-held device of claim 6, further comprising a character region, the character region including a plurality of icons corresponding to the positioning inputs of the rotary wheel, each icon including a plurality of characters.

8. The hand-held device of claim 6, further comprising an indicator to indicate the positioning input the rotary wheel locates.

9. The hand-held device of claim 8, wherein the indicator is placed out of the rotary wheel.

10. The hand-held device of claim 6, wherein the switch is a button.

11. The hand-held device of claim 10, wherein the button is placed on the rotary wheel.
